(19) United States
(12) Patent Application Publication
(10) Pub. No.: US 2014/0019052 A1
(43) Pub. Date: Jan. 16, 2014

(54) DEVICE AND METHOD FOR PREDICTIVE CALIBRATION

(71) Applicants: Ralf Zaeper, Hannover (DE); Frank Wiese, Lachendorf (DE); Matthias Moeller, Braunschweig (DE)

(72) Inventors: Ralf Zaeper, Hannover (DE); Frank Wiese, Lachendorf (DE); Matthias Moeller, Braunschweig (DE)

(73) Assignee: BAKER HUGHES INCORPORATED, Houston, TX (US)

(21) Appl. No.: 13/548,666

(22) Filed: Jul. 13, 2012

(51) Int. Cl. G01V 1/36; G06F 19/00; G01D 18/00

(52) U.S. Cl. 702/8; 702/85; 702/6; 702/11

(57) ABSTRACT

A method of calibrating a measurement device includes: compiling historical calibration data for the measurement device, the historical calibration data including values corresponding to outputs of the measurement device over a first operating duration in environmental conditions associated with an operating environment; projecting the historical calibration data over a subsequent operating duration to generate predictive calibration data; disposing the measurement device in the operating environment and generating measurement signals during the first operating duration and the subsequent operating duration; and generating measurement values from measurement signals generated during the subsequent operating duration based on the predictive calibration data.

### BACKGROUND

Many components, including electronic components and sensors, change their physical behavior upon exposure to environmental changes such as elevated temperatures, temperature-time gradients, pressure variances and gradients, and exposure to radiation.

In the oil and gas and chemical industries, sensors and electronics are often exposed to extreme temperature and pressure environments. Accurate sensor readings and accurately working electronics and other technical systems are needed to work under such conditions. Typically, technical systems are built and pre-treated prior to deployment such that they work as accurately and behave as precisely as possible, meaning certain variables or outputs are within close limits and nearly the same under the same external conditions. For measurement systems, outputs under a given environment are then translated or mapped into physical units by means of a calibration.

### SUMMARY OF THE INVENTION

A method of calibrating a measurement device includes: compiling historical calibration data for the measurement device, the historical calibration data including values corresponding to outputs of the measurement device over a first operating duration in environmental conditions associated with an operating environment; projecting the historical calibration data over a subsequent operating duration to generate predictive calibration data; disposing the measurement device in the operating environment and generating measurement signals during the first operating duration and the subsequent operating duration; and generating measurement values from measurement signals generated during the subsequent operating duration based on the predictive calibration data.

A computer program product for calibrating a measurement device, the computer program product including a non-transitory tangible storage medium readable by a processing circuit and storing instructions for execution by the processing circuit for performing a method including: compiling historical calibration data for the measurement device, the historical calibration data including values corresponding to outputs of the measurement device over a first operating duration in environmental conditions associated with an operating environment; projecting the historical calibration data over a subsequent operating duration to generate predictive calibration data; receiving measurement signals from the measurement device disposed in the operating environment during the first operating duration and the subsequent operating duration; and generating measurement values from measurement signals received during the subsequent operating duration based on the predictive calibration data.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts an exemplary embodiment of a subterranean well drilling, evaluation, exploration and/or production system;

FIG. 2 is a flow chart illustrating an exemplary method of generating, collecting and/or processing measurement data, and calibrating the data; and.

FIG. 3 depicts exemplary calibration data including exemplary historical data for a number of pressure sensors that exhibit similar behavior.

FIG. 4 depicts exemplary calibration data including exemplary historical data for a number of pressure sensors that exhibit individually different behavior.

### DETAILED DESCRIPTION

Systems and methods for performing sensor measurements or other types of data collection and calibration of sensors or other data collection devices, such as borehole sensors, are described herein. A calibration method includes collecting measurement data from one or more devices and calibrating the devices during or after measurement based on predictive calibration data generated from previously determined sensor measurement and/or calibration data. The method allows for predictive calibration adjustment or self-calibration of technical systems (e.g., measurement systems) based on knowledge of system behavior under given conditions. Predictive calibration data is derived from previously determined historical data, such as individual trend testing or knowledge of expected system behavior by statistical trends. The systems and methods described herein allow for extension of the time required between calibrations and improvement of long term repeatability of a system, and can also account for changes in precision or repeatability beyond the limitations of precollected data.

In one embodiment, there is provided a prediction algorithm describing prior observed system behavior under known conditions. Historical calibration data is collected and/or generated for a data collection device that is exposed to a downhole or other environment during an operating duration or other selected time period. Predictive calibration data is generated by projecting the historical calibration data over a time period subsequent to the operating duration. This algorithm can provide calibration data for an operating environment that is static or that changes over time, and adjust calibration according to historic exposure of the device. The predictive calibration data may also be based on predicted changes of the operating environment and/or device during the subsequent time period or duration.

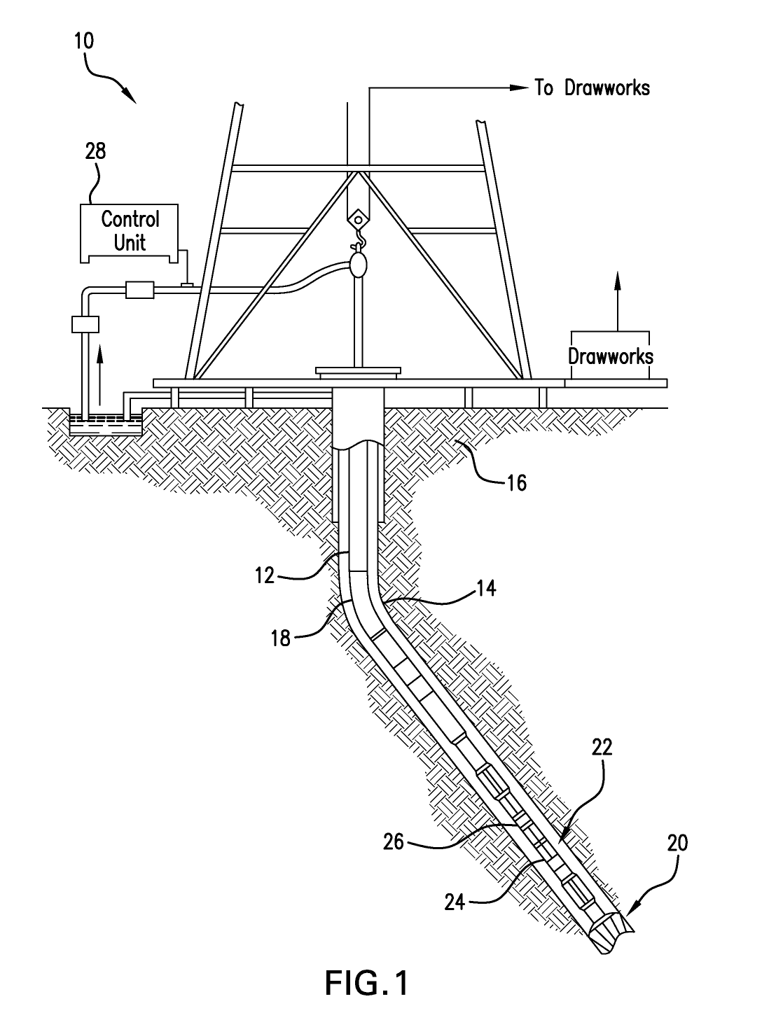

Referring to FIG. 1, an exemplary embodiment of a subterranean well drilling, evaluation, exploration and/or production system 10 includes a borehole string 12 that is shown disposed in a borehole 14 that penetrates at least one earth formation 16 during a subterranean operation. The borehole string 12 includes any of various components to facilitate subterranean operations. As described herein, “borehole” or “wellbore” refers to a single hole that makes up all or part of a drilled well. As described herein, “formations” refer to the various features and materials that may be encountered in a subsurface environment and surround the borehole.

In one embodiment, the borehole string 12 includes one or more pipe sections 18 or coiled tubing that extend downward into the borehole 14. In one example, the system 10 is a drilling system and includes a drill bit assembly 20. The system 10 may also include a bottomhole assembly (BHA) 22. The system 10 and/or the borehole string 12 include any number of downhole tools 24 for various processes including drilling, hydrocarbon production, and formation evaluation (FE) for measuring one or more physical quantities in or around a borehole. Although the borehole string 12 and the tools 24 are shown in a drilling system, they are not so limited. The tools 24 can be lowered into the borehole 12 by any suitable means, such as via a wireline.

In one embodiment, the system 10, the tools 24, pipe sections 18, the borehole string 12 and/or the BHA 22 include at least one sensor 26, such as a pressure and/or force sensor configured to measure various forces on system components, in the borehole 12 and/or in the surrounding formation 16. Exemplary forces include pressure from drilling, production and/or borehole fluids, pressure from formation materials, gravity (acceleration) and axial force on components of the borehole string 12. Sensors 26 can also be configured to measure various formation and/or borehole properties. Exemplary sensors include temperature sensors, resistivity sensors, nuclear magnetic resonance (NMR) sensors, pulsed neutron measurement devices, gamma ray sensors and others. The types and numbers of sensors 26 described herein are not limited, and may include any sensor or other data collection device for which outputs are calibrated based on changes in the device over time and/or due to operating environment exposure.

In one embodiment, the tools 24 and/or sensors 26 are equipped with transmission equipment to communicate ultimately to a surface processing unit 28. Such transmission equipment may take any desired form, and different transmission media and connections may be used. The surface processing unit 28 receives signals from the downhole sensors and devices and processes such signals according to programmed instructions provided to the surface processing unit 28. In addition to (or in place of) the surface processing unit 28, a downhole processor may be used to perform various functions for evaluation and analysis of data.

In one embodiment, the surface processing unit 28, the tool 24 and/or other components of the system 10 include devices as necessary to provide for storing and/or processing data collected from the sensors 26 and other components of the system 10. Exemplary devices include, without limitation, at least one processor, storage, memory, input devices, output devices and the like.

The surface processing unit 28 or other processor is configured to generate, receive and/or store historical calibration and predictive calibration data that can be used to calibrate the sensors 26 to account for changes in the sensors 26 that occur over time and/or in response to various operating and/or environmental conditions. The surface processing unit 28 may also be configured to generate the predictive calibration data from predetermined data and/or adjust the calibration of received data or signals based on the predictive calibration data.

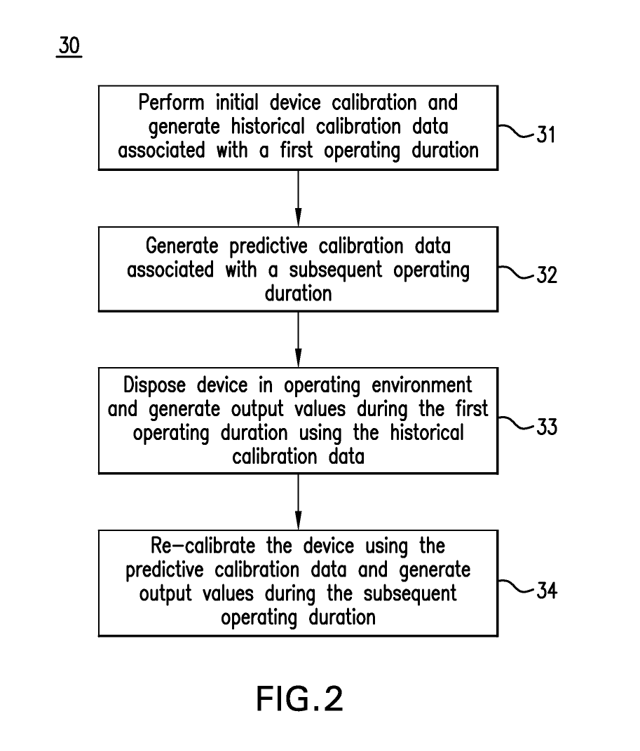

FIG. 2 illustrates a method 30 of generating and processing signals and data received from measurement devices or other data producing devices. Although the method is described in conjunction with the downhole system 10, it is not so limited. The method may be performed in conjunction with any suitable processor and with any (surface or downhole) sensor or other device that generates signals and may need calibration. The method 30 includes one or more stages 31-34. In one embodiment, the method 30 includes the execution of all of stages 31-34 in the order described. However, certain stages may be omitted, stages may be added, or the order of the stages changed.

In the first stage 31, a measurement and/or data collection device such as the sensor 26 is initially calibrated. In this example, the sensor 26 is a pressure sensor. In addition to sensors, various other components of data collection devices can be affected by downhole or other environmental conditions, which in turn affect device output. For example, electronic components, electronic bridges and electronics adjacent to sensors can change behavior over time in some conditions. The measurement device, e.g., sensor 26, is not limited to the embodiments described herein. For example, the measurement device can be an accelerometer, optical sensor, radiation sensor, temperature sensor, or any other device for measuring a physically measurable condition.

The sensor 26 is initially calibrated by associating sensor outputs with corresponding measurement values. The initial calibration may be performed using calibration data generated by exposing the sensor 26 to various pressures in a known environment, e.g., in an environment having a known temperature. In other embodiments, the sensor 26 is initially calibrated using previously known calibration data, such as calibration data generated from other equivalent sensors or data generated from the sensor 26 (or equivalent sensors) in previous experimental or operational environments.

In one embodiment, the calibration data is used to correlate device output to data values, e.g., measurement values. Exemplary calibration data includes calibration coefficients applied to device output signals, and scaling factors or other values that can be applied to either output signals or correlated measurement values. For example, calibration data is generated that correlates voltage outputs from the sensor 26 to pressure values. Exemplary calibration data includes a calibration table and a calibration curve. The calibration may be managed by a calibration table, a polynomial, a curve or other mathematical function with values or coefficients stored in memory.

For example, a pressure sensor ideally puts out a certain voltage at given pressure and given temperature. Based on this pressure-temperature dependency, a calibration table is created translating a given voltage at a given measured temperature into a pressure value.

Historical calibration data is collected and/or generated that is used to associate sensor outputs during an operating duration with measurement values. As described herein, an “operating duration” is a length of time during which a sensor or other data collection device is operated in a measurement environment. This length of time, which can be a continuous length or a multiple of smaller time lengths, can be any time period during which the sensor is operated and used to measure properties. During the operating duration, the sensor 26 is known to be exposed to various environmental conditions, such as temperature and pressure, the values of which are known or at least estimable. Such conditions can be approximately constant, or one or more of the conditions can change in a known manner over the course of the operating duration.

In one embodiment, the pressure sensor 26 is placed in an environment in which the pressure is known and can be modified. The environment may also include other known conditions, such as temperature and vibration, which affect the output of the sensor and can also change the sensor over time. In the environment, the sensor 26 is activated in a plurality of known pressures and the output of the sensor is recorded for each pressure to generate historical calibration data. As with the initial calibration data, (which may be incorporated with the historical calibration data), in one embodiment, the calibration data includes previously known calibration data, such as calibration data generated from other equivalent sensors or data generated from the sensor (or equivalent sensors) in previous experimental or operational environments.

For example, for a downhole environment, the historical calibration data is generated and/or collected for a time during which the sensor 26 is disposed in a borehole and advanced to a selected location. The historical data can include calibration data associated with a plurality of pressures and temperatures that are known or estimated to be experienced by the sensor 26 during the downhole operation. For example, as the sensor 26 is lowered through the borehole, the sensor may experience successively increasing temperatures and pressures. Other conditions that can be experienced include gravitational field, acceleration, deformation, vibration, shock and radiation.

In one embodiment, the historical data is processed or analyzed to, e.g., generate a curve or function that can be extrapolated or projected beyond the range of the historical data. For example, a trend line 46 or function is used to describe the drift behavior of the sensors and represent the historical data. Statistical analysis, curve fitting, regression or other methods may be used to analyze the historical data.

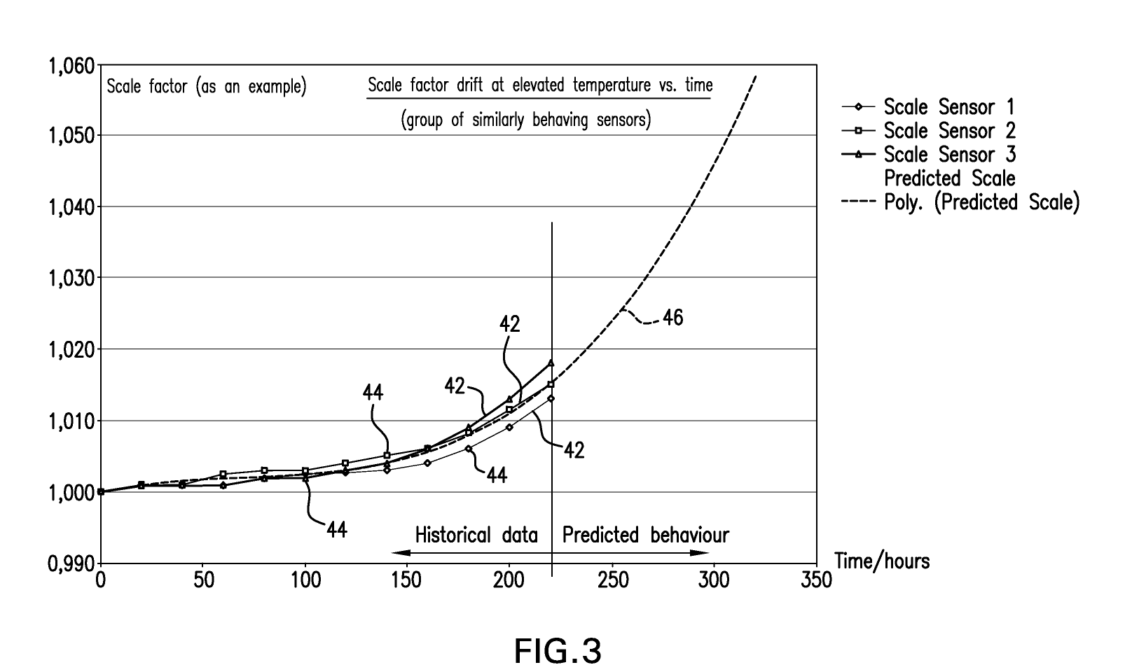

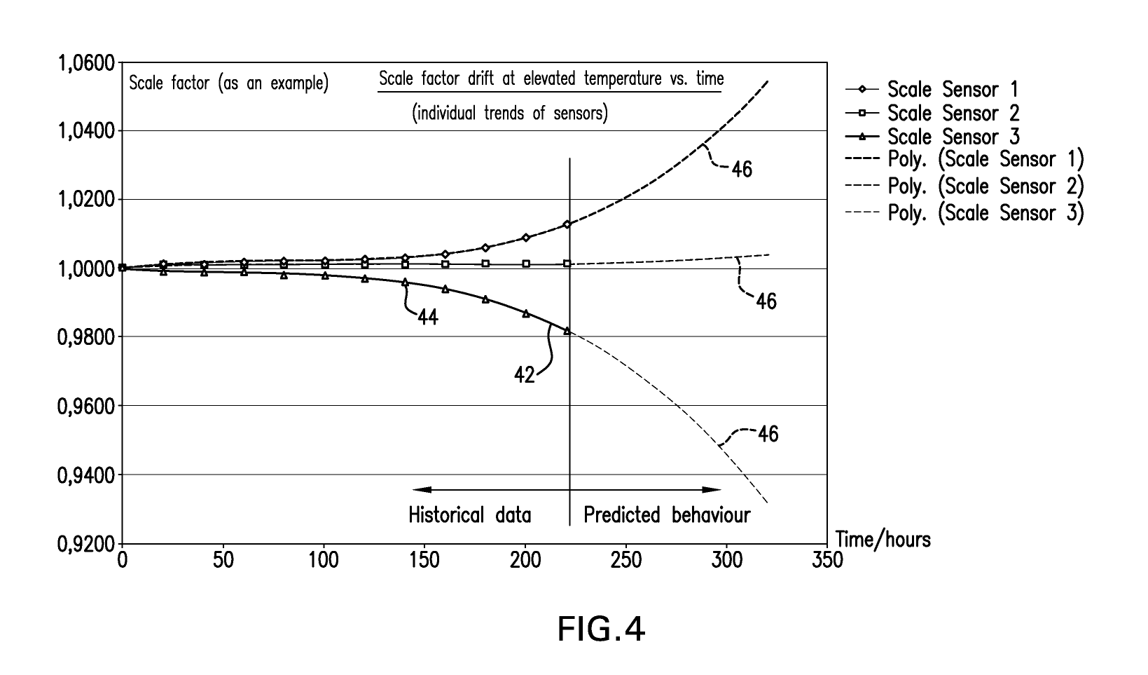

FIGS. 3 and 4 illustrate examples of historical calibration data for a pressure sensor. FIG. 3 shows historical data including previously determined scaling factors applied to pressure data from the sensors 26. This historical data illustrates scale factor drift behavior with time under a given temperature measured on three samples which behave very similarly. Curve 42 includes scale factor values 44 for three pressure sensors that were calculated by exposing the sensors to selected pressure conditions (e.g., known estimated temperatures and pressures affecting the sensors in a downhole environment) over an operating duration. As shown in FIG. 3, the collected historical calibration data, i.e., scaling factor, was determined over a period of about 220 hours. A trend line 46, as an example, is generated and used to indicate the predicted future behavior of the sensors. FIG. 4 shows similar exemplary data for a group of sensors with individual behavior, each having a curve 42 and an associated trend line 46.

With knowledge of the sensor behavior over an operating duration, the behavior of the sensor during subsequent time periods can be forecasted and calibration values, such as the scaling factors shown in FIGS. 3 and 4, can be adjusted.

In the second stage 32, predictive calibration data is generated. The predictive calibration data allows for calibration of data collection devices, e.g., measurement systems, based on knowledge of system behavior under given conditions derived from the historical calibration data.

This stage may be performed via a prediction algorithm describing prior observed sensor behavior under known conditions, e.g., using the historical calibration data. This algorithm can not only map the technical system as a snap shot function but can also adjust historical calibration coefficients and/or generate predictive calibration data according to historic exposure of the sensor 26 to an operating environment and based on predicted changes of the operating environment.

With the knowledge of the sensor behavior over time, gained by means of observing a trend behavior for a shorter test exposure time or knowledge of typical behavior, the calibration can be adjusted based on the stored historical calibration data. This predictive calibration can extend the time between calibration and re-calibration, thus extending the time between maintenance of the sensor system.

In this step, a processor such as the surface processing unit 28, analyzes the historical data and projects the historical data to an operating duration that is subsequent to the first operating duration. In this way, calibration data can be generated that includes calibration values over time that exceeds the operating time for which the historical calibration data was collected and/or generated.

The predictive data, in one embodiment, includes calibration data reflecting multiple environmental conditions, such as temperature and pressure. The values of these conditions are estimated based on conditions observed during the first operating duration during which the historical data was collected.

In one embodiment, the predictive data provides a predictive description of expected changes in the conditions. For example, the historical data provides calibration data for the sensor as it is lowered into a borehole and advanced through various depths during the first operating duration. Changes in temperature, pressure and other conditions are accounted for and provided as part of the historical calibration data. During the subsequent operating duration, further condition changes are predicted. For example, the sensor may be advanced to greater depths than those achieved during the first duration. In addition, the subsequent duration may also account for condition changes during retrieval of the sensor.

For example, referring again to FIGS. 3 and 4, the trend line is projected via any suitable method to generate scaling factors over time periods beyond the 220 hour operating time provided by the historical data.

In the third stage 33, the sensor is disposed in an operating environment, and measurement values are generated during the first operating duration. The measurement values are generated from sensor outputs using the historical calibration data.

In one embodiment, the sensor 26 is deployed downhole for performance of a downhole measurement operation, e.g. a wireline or LWD operation. For example, the sensor 26 is incorporated into a pipe section or other component deployed in a downhole environment. An environmental condition such as force and/or pressure (e.g., drilling fluid pressure or pressure due to other downhole fluids) is applied to the sensor, causing the sensor to output a signal when operated. In the present example, the pressure sensor 26 outputs a voltage to a user or processor, such as the surface processing unit 28. The processor associates the voltage signals with pressure values using the historical calibration data, and outputs the pressure values, e.g., to a user, display or other location.

In the fourth stage 34, the sensor 26 is re-calibrated using the predictive data (e.g., projection of the trend line 46). With time and exposure to temperature and pressure (and/or other condition variables), mapping of output voltage to pressure becomes less accurate due to aging or deterioration. The sensor 26 is re-calibrated in order to stay within given limits for pressure reading accuracy. Sensor output signals received during the subsequent operating duration are correlated to predictive calibration data corresponding to the time of each output and the predicted operating conditions at the time of the output signal.

In one embodiment, re-calibration is initiated by a “quality trigger,” or detection of a condition indicating the need to re-calibrate or at least check calibration. For example, a quality trigger to re-calibrate the gravity sensor is detected by continuously or periodically analyzing received data. For example, if the sensor includes three orthogonal accelerometers (e.g., x, y, z), the total gravity field can be periodically calculated by vector addition of accelerometer data. If the total gravity field changes beyond a selected amount, re-calibration is triggered as the gravity sensor needs correction.

In another example, measurements of conditions around the tool are measured to determine whether conditions have changed such that re-calibration is needed. For example, a separate downhole temperature sensor may be utilized or a surface pressure measurement (in combination with mud flow rate) can indicate a downhole pressure condition that may require re-calibration. In one embodiment, a trigger can be set whenever measured condition data deviates from an expected range based on, e.g., second or more measurements and/or underlying physical models.

In one embodiment, re-calibration in the fourth stage 34 could be also a continuous process of calibration data adjustment.

The apparatuses and methods described herein provide various advantages over existing methods and devices. For example, because the calibration data is projected over some future time past the time associated with historical data, less historical data is required, and the sensors do not have to be retrieved as early or as often.

In connection with the teachings herein, various analyses and/or analytical components may be used, including digital and/or analog systems. The apparatus may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention.

What is claimed is:

1. A method of calibrating a measurement device, comprising:
compiling historical calibration data for the measurement device, the historical calibration data including values corresponding to outputs of the measurement device over a first operating duration in environmental conditions associated with an operating environment;
projecting the historical calibration data over a subsequent operating duration to generate predictive calibration data;
disposing the measurement device in the operating environment and generating measurement signals during the first operating duration and the subsequent operating duration; and
generating measurement values from measurement signals generated during the subsequent operating duration based on the predictive calibration data.

2. The method of claim 1, wherein the measurement device is a sensor configured to be disposed in a downhole operating environment.

3. The method of claim 2, wherein the measurement device is selected from at least one of a downhole pressure sensor, an accelerometer, an optical sensor, a radiation sensor and a temperature sensor.

4. The method of claim 1, wherein the environmental conditions include conditions experienced by the measurement device in a downhole environment.

5. The method of claim 4, wherein the environmental conditions are selected from at least one of temperature, pressure, deformation, vibration, shock and radiation.

6. The method of claim 4, wherein the environmental conditions include temperature and pressure conditions that change over the course of the first operating duration.

7. The method of claim 6, wherein the temperature and pressure conditions change as the measurement device is advanced from a surface toward a downhole location.

8. The method of claim 1, wherein compiling the historical data includes processing the historical data to generate a curve of calibration values over time.

9. The method of claim 8, wherein projecting the historical calibration data includes generating a trend line from the calibration curve, and projecting the trend line over the subsequent operating duration.

10. The method of claim 1, wherein the step of calibrating is triggered by at least one of an environmental measurement or reference value and a measurement from the measurement device.

11. The method of claim 1, wherein the step of calibrating is performed at least substantially continuously.

12. A computer program product for calibrating a measurement device, the computer program product including a non-transitory tangible storage medium readable by a processing circuit and storing instructions for execution by the processing circuit for performing a method comprising:
compiling historical calibration data for the measurement device, the historical calibration data including values corresponding to outputs of the measurement device over a first operating duration in environmental conditions associated with an operating environment;
projecting the historical calibration data over a subsequent operating duration to generate predictive calibration data;
receiving measurement signals from the measurement device disposed in the operating environment during the first operating duration and the subsequent operating duration; and
generating measurement values from measurement signals received during the subsequent operating duration based on the predictive calibration data.

13. The computer program product of claim 12, wherein the measurement device is a sensor configured to be disposed in a downhole operating environment.

14. The computer program product of claim 13, wherein the measurement device is selected from at least one of a downhole pressure sensor, an accelerometer, an optical sensor, a radiation sensor and a temperature sensor.

15. The computer program product of claim 12, wherein the environmental conditions include conditions experienced by the measurement device in a downhole environment.

16. The computer program product of claim 15, wherein the environmental conditions are selected from at least one of temperature, pressure, deformation, vibration, shock and radiation.

17. The computer program product of claim 15, wherein the environmental conditions include temperature and pressure conditions that change over the course of the first operating duration.

18. The computer program product of claim 17, wherein the temperature and pressure conditions change as the measurement device is advanced from a surface toward a downhole location.

19. The computer program product of claim 12, wherein compiling the historical data includes processing the historical data to generate a curve of calibration values over time.

20. The computer program product of claim 19, wherein projecting the historical calibration data includes generating a trend line from the calibration curve, and projecting the trend line over the subsequent operating duration.

21. The computer program product of claim 12, wherein the step of calibrating is triggered by at least one of an environmental measurement or reference value and a measurement from the measurement device.

22. The computer program product of claim 12, wherein the step of calibrating is performed at least substantially continuously.
